(19) United States
(12) Patent Application Publication
(10) Pub. No.: US 2019/0318438 A1
(43) Pub. Date: Oct. 17, 2019

(54) REAL-TIME ASSOCIATE DECISION AND RELAY SYSTEM

(71) Applicant: BANK OF AMERICA CORPORATION, Charlotte, NC (US)

(72) Inventors: Alan K. Bobbit, JR., Charlotte, NC (US); Jolaine Pearson Blankenship, Salisbury, NC (US); Teron Wayne Douglas, Roswell, GA (US); John T. Jordan, Charlotte, NC (US); Jeff Lojko, Miami, FL (US); Greg P. Niosi, Mansfield, MA (US); Stephen Thomas Shannon, Charlotte, NC (US)

(73) Assignee: BANK OF AMERICA CORPORATION, Charlotte, NC (US)

(21) Appl. No.: 16/128,643

(22) Filed: Sep. 12, 2018

Related U.S. Application Data
(60) Provisional application No. 62/658,264, filed on Apr. 16, 2018.

(51) Int. Cl. G06Q 50/20; G06Q 10/06

(52) U.S. Cl. CPC G06Q 50/2057; H04L 67/10; G06Q 10/06398; G06Q 10/06393

(57) ABSTRACT

Embodiments of the invention are directed to systems, methods, and computer program products for a real-time inter-entity associate decision and relay. In this way, the invention provides a decision engine for decision making for uniform associate decisioning across an entity. The system comprises a platform agnostic decision and relay system for an entity that integrates across entity platforms, wherein integrating across entity platforms comprises reading and transmitting, compatibly, in one or more platform. The invention extracts data points from one or more platforms within an entity about an associate along with learning resources to generate a decision and relay system for the particular associate. The invention tailors decisions to identify specific functions or actions an associate should perform along with pinpointed direction for identification of how those functions are formulated and performed.

### CROSS-REFERENCE TO RELATED APPLICATION(S)

This application is a non-provisional filing of U.S. Patent Application No. 62/658,264 filed Apr. 16, 2018, entitled “Real-Time Associated Decision and Relay System,” the contents of which are hereby incorporated by reference.

### BACKGROUND

With advancements in technology and growth of entities, training platforms are continually required for managers and associates. The training platforms are typically universal and mandatory for managers and associates.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The invention provides a decision engine and hub for decision making for uniform associate decisioning across an entity. The system comprises a platform agnostic decision and relay system for an entity. In this way, the system comprises a decision engine for associate performance, goals, coaching, or the like for management use and time management of the manager with respect to associate decisioning. The system extracts data points from one or more platforms within an entity about an associate along with learning resources to generate a decision and relay system for the particular associate. The system tailors decisions to identify specific functions or actions an associate should perform along with pinpointed direction for identification of how those functions are formulated and performed.

Embodiments of the invention relate to systems, methods, and computer program products for real-time associate decisioning and relaying, the invention comprising: integrating across entity platforms, wherein integrating across entity platforms comprises compatibly reading and transmitting in one or more platform; compiling associate and manager hierarchal data and learning resources across an entity; generating a decision and relay tool comprising review metrics and actions for manager deployment to associates; deploying, via an interactive interface the decision and relay tool, wherein the decision and relay tool is integrated within a device for performance and metric monitoring; and collecting review metrics and actions of associate and continually modify deployed review metrics and actions based on performance.

In some embodiments, the invention further comprises incorporation of the decision and relay tool into workflow via initiation of the decision and relay tool upon start-up of a device on a network associated with the entity.

In some embodiments, the invention further comprises: identifying an associate that interacts with a customer; identifying the customer associated with the interaction; tracking customer interaction with the entity via alternative channels within a predetermined window of time after the associate interaction; and triggering associate benefits based on the customer interaction with the entity via the alternative channels.

In some embodiments, the invention further comprises providing a connectivity between associates for connection assessment issue based solution deployment, wherein the decision and relay tool performs learning of associate skills and deploys the associate via a connectivity across the entity for issue based solution deployment of the associate.

In some embodiments, integrating across entity platforms further comprises connect with and integrate for data distribution into the one or more platforms used by one or more lines of business across the entity providing a platform agnostic system integration for real-time associate decisioning and relaying, wherein the one or more platforms comprise employee management platforms, and product management platforms.

In some embodiments, generating review metrics and actions for manager deployment further comprises: eliminating top performing associates from the review metrics; identifying above average performing associates; identify learning resources and actions performed by the above average performing associates; and deploying, via the decision and relay tool, repeatable activities performed by the above average performing associates for review metrics and actions for associates.

In some embodiments, learning resources across the entity further comprises a suggested approach to presenting the review metrics and actions to the associate.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, where:

FIG. 1 illustrates a real-time associate decision and relay system environment, in accordance with embodiments of the present invention;

FIG. 2 illustrates a high level flowchart of real-time associate decision and relay tool generation and deployment, in accordance with embodiments of the present invention;

FIG. 3 illustrates a high level flowchart of post interaction monitoring for real-time associate decisioning, in accordance with embodiments of the present invention;

FIG. 4 illustrates a process for real-time decision and relay tool modifications, in accordance with embodiments of the present invention;

FIG. 5 illustrates a process for identification of repeatable activities and deployment of those activities within the decision and relay tool, in accordance with embodiments of the present invention;

FIG. 6 illustrates a process for deployment of new product initiatives via the decision and relay tool, in accordance with embodiments of the present invention;

FIG. 7 illustrates a process for qualifying learning resources, in accordance with embodiments of the present invention; and

FIG. 8 illustrates a process for issue based associate connection identification, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

In some embodiments, an “entity” may be a financial institution, business, or the like. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant itself.

In some embodiments, a “user” may refer to one or more individuals within an entity that may have access to the associate decision and relay tool. The user may include a manager or an associate associated with the entity. In some embodiments, the user may be a manager of one or more associates within an entity. As such, the user is an individual who may have some management, senior, or leadership role within one or more branches of an entity. This may include management of one associate or more. In some embodiments, a user may also be an associate.

The invention comprises an across entity decision and relay hub for platform agnostic integration for associate manager communication and coaching assistance. The system integrates observations from managers, customer engagement information, assorted information from channels such as email, voice, or the like, performance management information, sessions with managers, sessions with performance coaches, sessions with peer coaches, training modules, and the like. Using this information, the system integrates with learning resources to implore tactics for coaching assistance and overall management consistence across an entity.

The invention provides a decision engine and hub for decision making for uniform associate decisioning across an entity. The system comprises a platform agnostic decision and relay system for an entity. In this way, the system comprises a decision engine for associate performance, goals, coaching, or the like for management use and time management of the manager with respect to associate decisioning. The system extracts data points from one or more platforms within an entity about an associate along with learning resources to generate a decision and relay system for the particular associate. The system tailors decisions to identify specific functions or actions an associate should perform along with pinpointed direction for identification of how those functions are formulated and performed.

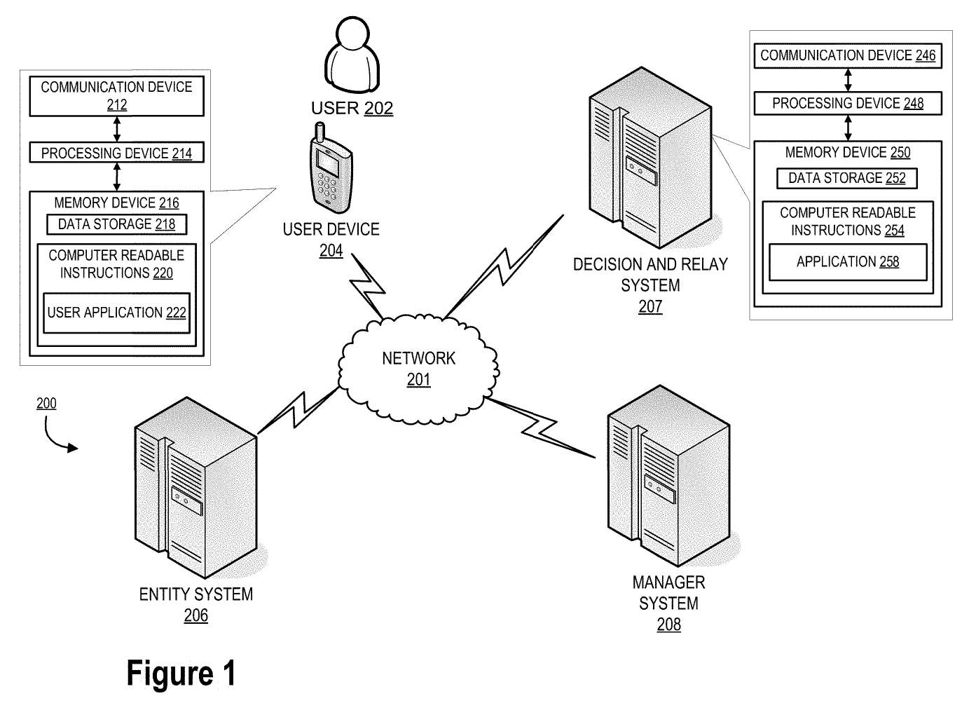

FIG. 1 illustrates a real-time associate decision and relay system environment 200, in accordance with embodiments of the present invention. FIG. 1 provides the system environment 200 for which the distributive network system with specialized data feeds. FIG. 1 provides a unique system that includes specialized servers and system communicably linked across a distributive network of nodes required to perform the functions of providing a decision engine for decision making for uniform associate decisioning across an entity.

As illustrated in FIG. 1, the manager system 208 is operatively coupled, via a network 201 to the user device 204, decision and relay system 207, and to the entity system 206. In this way, the manager system 208 can send information to and receive information from the user device 204, decision and relay system 207, and the entity system 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is one or more individuals associated with an entity. The user may be a manager of one or more associates within an entity. As such, the user is an individual who may have some management, senior, or leadership role within one or more branches of an entity. This may include management of one associate or more. In some embodiments, the user may be an associate associated with the entity under one or more managers. FIG. 1 also illustrates a user device 204. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the entity system 206, the manager system 208, and the decision and relay system 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to set up marker codes and communicate with the entity system 206.

As further illustrated in FIG. 1, the decision and relay system 207 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the manager system 208, the entity system 206, and the user device 204. As such, the communication device 246 generally comprises a modem, server, or other device for communicating with other devices on the network 201.

As further illustrated in FIG. 1, the decision and relay system 207 comprises computer-readable instructions 254 stored in the memory device 250, which in one embodiment includes the computer-readable instructions 254 of an application 258. In some embodiments, the memory device 250 includes data storage 252 for storing data related to the system environment 200, but not limited to data created and/or used by the application 258.

In one embodiment of the decision and relay system 207 the memory device 250 stores an application 258. Furthermore, the decision and relay system 207, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 246 to communicate with and ascertain data from one or more manager system 208, decision and relay system 207, and/or user device 204.

As illustrated in FIG. 1, the entity system 206 is connected to the manager system 208, user device 204, and decision and relay system 207. The entity system 206 has the same or similar components as described above with respect to the user device 204 and the decision and relay system 207.

As illustrated in FIG. 1, the manager system 208 is connected to the decision and relay system 207, user device 204, and entity system 206. In other embodiments, the manager system 208 may be a third party system separate from the entity system 206. The manager system 208 has the same or similar components as described above with respect to the user device 204 and the entity system 206. While only one manager system 208 is illustrated in

FIG. 1, it is understood that multiple manager system 208 may make up the system environment 200.

It is understood that the servers, systems, and devices described herein illustrate one embodiment of the invention. It is further understood that one or more of the servers, systems, and devices can be combined in other embodiments and still function in the same or similar way as the embodiments described herein. The manager system 208 may generally include a processing device communicably coupled to devices as a memory device, output devices, input devices, a network interface, a power source, one or more chips, and the like. The manager system 208 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like. The memory device may store any of a number of applications or programs which comprise computer-executable instructions/code executed by the processing device to implement the functions of the manager system 208 described herein.

The invention comprises an across entity decision and relay hub for platform agnostic integration for associate manager communication and coaching assistance. The system integrates observations from managers, customer engagement information, assorted information from channels such as email, voice, or the like, performance management information, sessions with managers, sessions with performance coaches, sessions with peer coaches, training modules, and the like. Using this information, the system integrates with learning resources to implore tactics for coaching assistance and overall management consistence across an entity.

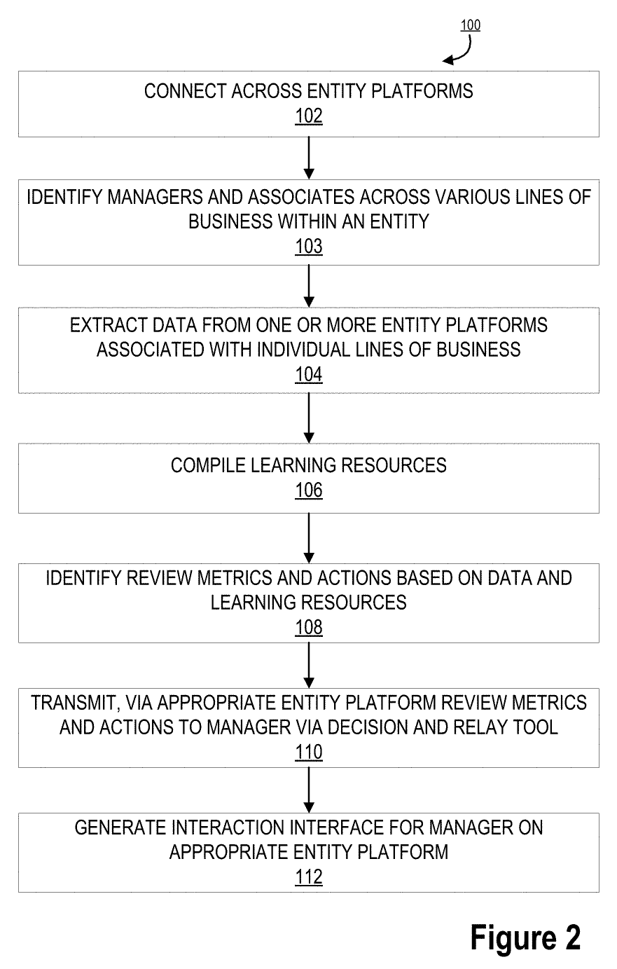

FIG. 2 illustrates a high level flowchart of real-time associate decision and relay tool generation and deployment 100, in accordance with embodiments of the present invention. As illustrated in block 102, the process 100 is initiated by connecting with platforms across the entity. In this way, the invention is an independent system that distributes out data one different platforms within the entity. In this way, the independent system may connect with and integrate for data distribution into the various platforms used by one or more lines of business across the entity. In this way, an entity may have one or more different lines of business, products, or the like that use different platforms within the line of business. The invention links within these various platforms to provide a platform agnostic system integration for real-time associate decisioning and relaying. The various platforms used across the entity may be employee management platforms, product management platforms, or the like.

As illustrated in block 103, the process 100 continues by identifying managers and associates across various lines of business within the entity. As such, the system identifies corporate structures of individual managers and associates under various managers. Also, the system identifies connections across entity individuals, including managers and/or associated where those individuals connect irrespective of corporate structure for advice, workflow, or issue based connections across individuals.

Next, as illustrated in block 104, the process 100 continues by extracting data from the one or more entity platforms associated with each of the individual lines of business. In this way, the system may extract associate management information, such as associate reviews, goals, job requirements, or the like. Furthermore, the system may include information extracted and compiled from various platforms may include observations from managers, customer engagement information, assorted information from channels such as email, voice, or the like, performance management information, sessions with managers, sessions with performance coaches, sessions with peer coaches, training modules, and the like. As illustrated in block 106, the system further comprises learning resources across the entity. Learning resources may include programs, processes, procedures, modules or the like for coaching career requirements, customer engagement strategies, action performance, or the like associated with a manager or associate employment tasks. The learning resources may include a suggested approach to presenting the review metrics and actions from the system or manager to the associate. These may be visual presentations, key words, performing, or the like.

As illustrated in block 108, the process 100 continues by identifying review metrics and actions that should be performed by a manager or associate based on the extracted data and the learning resources. These metrics and actions may be coaching strategies for an associate, performance enhancements for the associate, goals for an associate, training for an associate, engagement requirements, metrics, or the like. Furthermore, the system identifies management time delegations of associate review metrics to identify categories of time consumption for managers. As such, the system accounts for manager time and time consumption for each task for more efficient delegation of the time for the manager and the associate.

The system may then transmit, via an appropriate entity platform review, review metrics and actions to the manager for a specific associate, as illustrated in block 110. These metrics and actions may be tailored to the associate and/or the manager in a specific learning resource. The metrics and actions may be transmitted via a decision and relay tool on a platform used by the manager. As such, an interactive interface for the manager may be generated on the appropriate entity platform used by the manager, as illustrated in block 112. The interface may become integrated within the manager daily workflow for management and improvement of associate performance and metric monitoring. The interface may be used by the manager to conduct reviews of associates, provide actions for associates, monitor associates strengths, and the like.

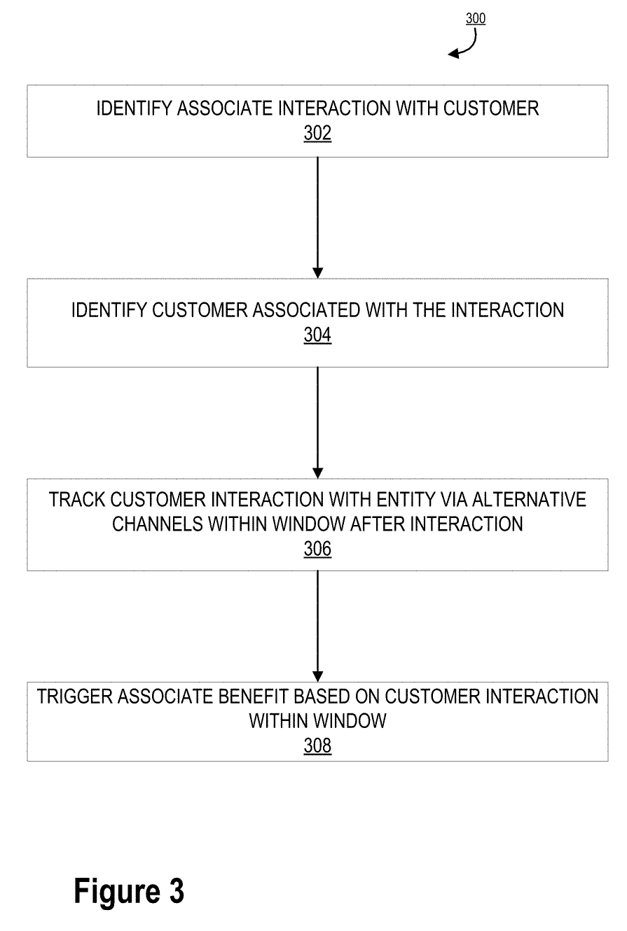

FIG. 3 illustrates a high level flowchart of post interaction monitoring for real-time associate decisioning 300, in accordance with embodiments of the present invention. As illustrated in block 302, the process 300 is initiated by identifying an associate interaction with a customer. In some embodiments, the associate may be a customer facing associate. In other embodiments, the system may identify that the associate is engaged in his/her employment obligations with one or more customers. Next, as illustrated in block 304, the system may identify the customer that the associate is interacting with. In this way, the customer may authenticate into a financial center, provide identification, or the like.

Upon completion of the customer interaction, the system may track customer interactions with the entity via various alternative channels within a window of time after the interaction, as illustrated in block 306. In this way, after the interaction in block 302, the system may monitor to identify the next customer communications with the entity. These communications may be via an alternative channel than the associate interaction with the customer. The system may identify the products/services of the interaction and track to identify if the customer pursues one or more of the products/services from that interaction at a future time. As illustrated in block 308, the process 300 continues by triggering an associate benefit upon identification that the customer selected a service/process that the associate discussed with the customer. The benefit may include one or more associate commissions, points, rewards, recognitions, or the like for credit for the product/service the customer selected that the associate discussed with the customer at a prior time.

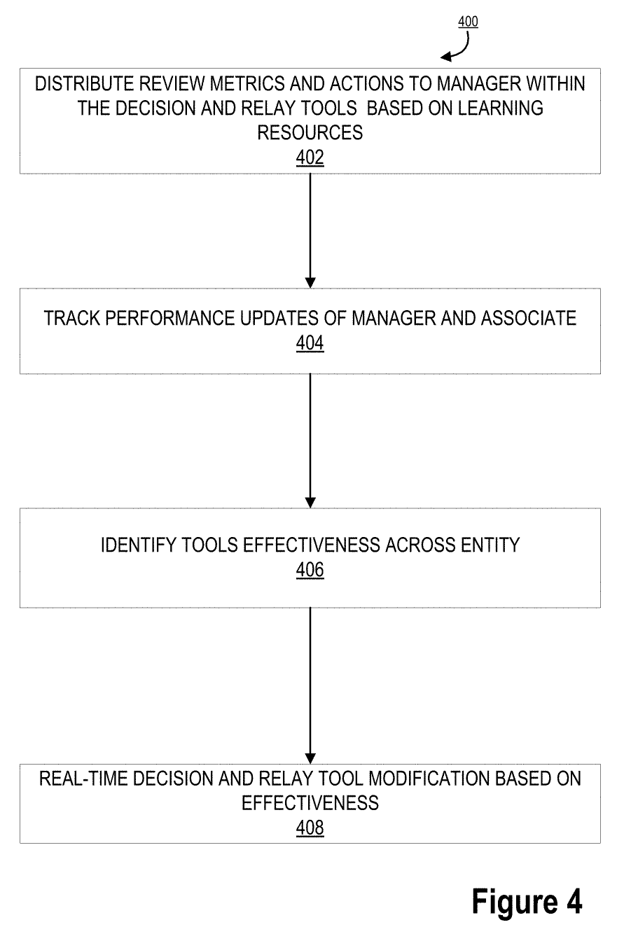

FIG. 4 illustrates a process for real-time decision and relay tool modifications 400, in accordance with embodiments of the present invention. As illustrated in block 402, the process 400 is initiated by distributing review metrics and actions to a manager within the decision and relay tool based on learning resources. In this way, the system may identify one or more items or actions for an associate to work on or focus on during his/her employment obligations. The tool may include review metrics such as associate performance, scoring, or the like. The tool may also include one or more items or actions for the user to work on based on entity determined metrics for focus, associate areas of improvement, or the like. These metrics and actions may be coaching strategies for an associate, performance enhancements for the associate, goals for an associate, training for an associate, engagement requirements, metrics, or the like. The system may then transmit, via an appropriate entity platform review, review metrics and actions to the manager for a specific associate. These metrics and actions may be tailored to the associate and/or the manager in a specific learning resource. The metrics and actions may be transmitted via a decision and relay tool on a platform used by the manager.

The manager may discuss the review metrics with the associate and present them in the tool recommended learning resource method. The learning resources may include programs, processes, procedures, modules or the like for coaching career requirements, customer engagement strategies, action performance, or the like associated with a manager or associate employment tasks. The learning resources may include a suggested approach to presenting the review metrics and actions from the system or manager to the associate. These may be visual presentations, key words, performing, or the like.

Furthermore, in some embodiments, the tool for the manager may comprise an artificial intelligence aspect that may identify specific top items for manager to look into. Furthermore, based on the top items for focus, the system may identify top individual associates for the manager to pinpoint and review. In some embodiments, the manager dashboard with manager accountability and consistency may be included within the tool.

After a period of time after the presentation of the review metrics and actions from the manager to the associate, the system may continue, as illustrated in block 404, by tracking the performance updates of the manager and/or the associate. As such, the system may monitor the associate performance across a time period after the associate review and actions to identify if the actions and review were received positively by the associate and actions were performed based on the positive reception.

The performance of the manager and the associates are tracked across the entity and across geographic location. Upon data gathering from the performance of the associate and manager tracking across the entity and across geographical locations, the system may determine the tools effectiveness across the entity, as illustrated in block 406. In this way, the system may identify the learning resources deployed and make a determination on if those resources were effective for specific associates, specific geographical locations, specific employment obligations, or the like. Some of the learning resources may be tailored for various learning types that may be better or worse performing than others in each geographic area and/or for each individual associate.

As illustrated in block 408, the process 400 continues by real-time decision and relay tool modification based on the identified effectiveness of the learning resources. In this way, the system reviews the data of efficiency and effectiveness of the decision and relay tool and continually modifies the tool learning resources and approaches for presentation of actions and review metrics to each individual associate. In this way, the system tailors specific metrics and learning resource styles to each individual associate based on the manager and the associate and their learning or work style. Furthermore, in some embodiments, the system may extract and/or review social media of associates and managers in order to further ascertain learning styles and the like.

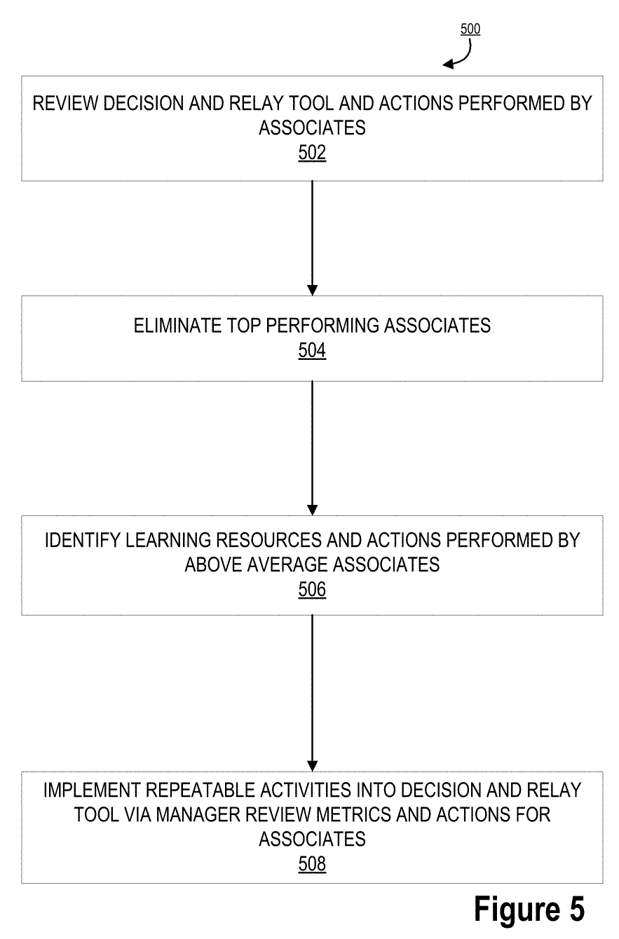

FIG. 5 illustrates a process for identification of repeatable activities and deployment of those activities within the decision and relay tool 500, in accordance with embodiments of the present invention. As illustrated in block 502, the process 500 is initiated by reviewing decision and relay tool and actions performed by the associates. In this way, the system identifies associates as top, middle, or low performers for one or more employment obligations. The system may eliminate the top performing associates, as illustrated in block 504. In this way, the system recognized that top performers may be outliers and/or the top associates may have various non-repeatable attributes that make the associate a top performer.

As illustrated in block 506, the process 500 continues by identifying the learning resources and actions performed by the above average associates for a particular employee obligation action. In this way, the system may recognize the above average associates in one or more activities and identify the actions the associate may perform to improve their abilities to above average. The actions may be repeatable and learnable actions.

As illustrated in block 508, the process 500 continues by implementing repeatable activities into decision and relay tool via manager review metrics and actions for associates. As such, the system identifies repeatable activities of above-average associates and implements those activities into the tool for implementation across the entity for that employment obligation.

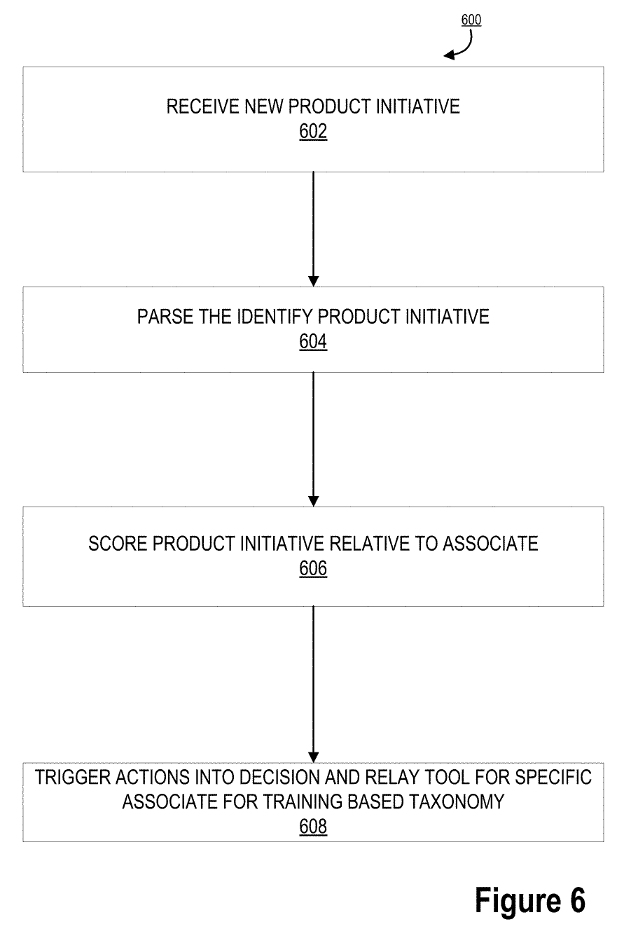

FIG. 6 illustrates a process for deployment of new product initiatives via the decision and relay tool 600, in accordance with embodiments of the present invention. As illustrated in block 602, the process 600 is initiated when a new product or service initiative is received. In this way, an entity may initiate a product or service initiative for a line of business or entity wide for deployment. The initiative may include products or services such as a procedure, software implementation, or the like.

Next, as illustrated in block 604, the process 600 continues by parsing out the identified product or service initiative. In this way, the system may separate out the various portions of the new initiative to its basic parts, such as basic functions, areas of implementation, or the like. The parsed initiative may then be scored relative to each individual associate, as illustrated in block 606. The scoring identifies specific parsed elements of the initiative that pertain to the associate. The higher the scoring, the more the initiative element will affect the associate's employment obligations. In some embodiments, initiatives may affect all aspects of the employment obligations of the associate. For example, software, hardware, products, or the like that the associate uses everyday may be changed, modified, or updated. As such, these elements of the initiative will impact the associate and his/her daily obligations. As such, entities typically deploy training for new products or new initiatives. The training may be in the form of modules, in person, or the like. By parsing out the initiative and scoring it for each specific associate, each associate's training for the initiative may be tailored to that associate. In this way, the system may identify the parts of the initiative that impact the associate and only train that associate for those elements. While other associates may be impacted by other elements of the initiative. This way, associates are not trained on elements that the associate will not be using in his/her employment obligations.

Next, as illustrated in block 608, the process 600 continues by triggering actions into the decision and relay tool for specific associate training based on the taxonomy of the initiative and the associate need for training for that specific portion of the initiative.

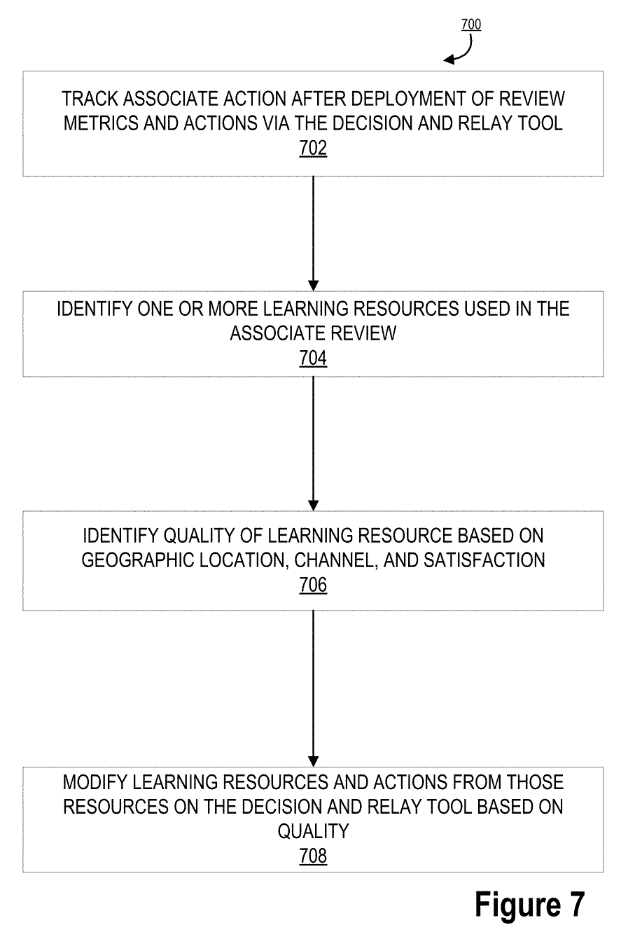

FIG. 7 illustrates a process for qualifying learning resources 700, in accordance with embodiments of the present invention. FIG. 7 illustrates qualifying learning resources to identify current entity training or coaching and identify the effectiveness of that training. In this way, the system may modify training or coaching mechanisms across the entity in real-time based on effectiveness. As illustrated in block 702, the process 700 is initiated by tracking associate action after deployment of review metrics and actions via the decision and relay tool. As such, the associate may have been presented with review metrics and actions from one or more managers via one or more learning resource means. After the action request and coaching was provided to the associate, the system may track associate actions.

As illustrated in block 704, the system may identify the one or more learning resources used by the manager in the associate review. In this way, the system may identify the processes, tools, or approach used by a manager with each specific associate. The system may continue by comparing the tracked associate actions that occurred after the review metrics were deployed with the learning resource that was used to deploy the review metrics to identify a quality of learning resources based on specific factors such as geographic location, channel, and satisfaction, as illustrated in block 706. In this way, the system may identify one or more learning resources that may be sufficient in specific geographical locations compared to others. As such, the system identifies greater customer satisfaction based on a specific associate approach to the customer as opposed to a different approach. The way the associate interacts with the customer may be included in the learning resources. The learning resources may further include training modules, training tools, teaching modules, procedures, advice, employment obligation training, performance coaching, or the like.

Based on the quality of learning resources, the system may modify actions the associate is trained to perform in order to increase customer satisfaction by modifying the learning resources on the decision and relay tool based on the quality identification, as illustrated in block 708. The system may also identify and incorporate various associate learning styles into the learning resources and actions.

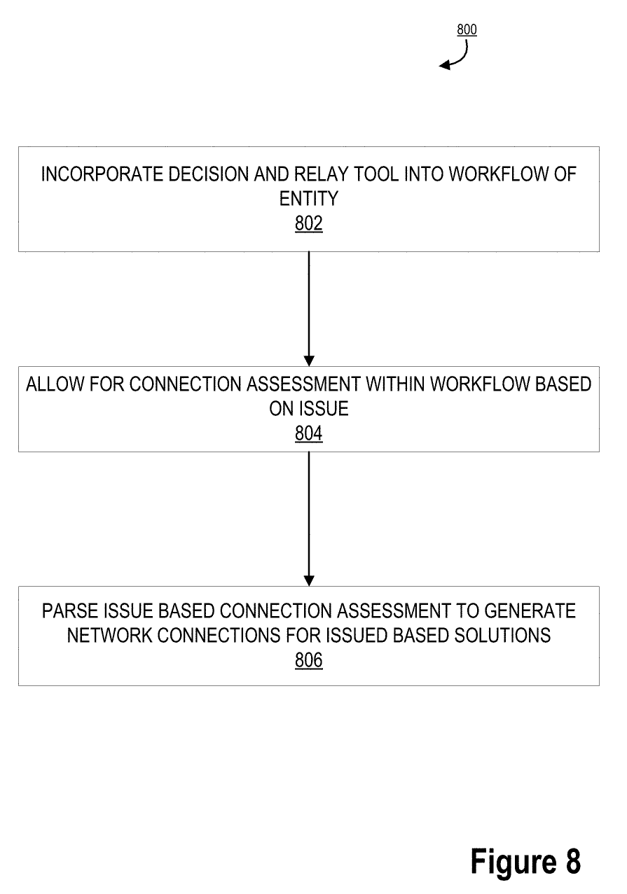

FIG. 8 illustrates a process for issue based associate connection identification 800, in accordance with embodiments of the present invention. As illustrated in block 802, the process 800 is initiated by incorporating the decision and relay tool into the workflow of an entity. In this way, the tool may be integrated into manager systems and user devices. The tool may activate upon start-up of the devices and be deployed across the network. As illustrated in block 804, the process 800 continues by allowing for connection assessment within workflow based on various issues. As such, the tool may identify connections across associates and/or managers. These connections may be one or more individuals that work together even if they are not under the same manager or in the same line of business. In this way, the system learns associate strengths and positions that may aid in solving one or more issues. As such, the system identifies associates and managers that have skills required for solving one or more issues that may arise within the entity.

As illustrated in block 806, the process 800 continues by parsing the issue based connection assessments to generate network connections for issued based solutions within the entity. As such, the tool may then generate a decision or knowledge tree that fluidly interlinks associates and managers via connections based on issues.

The invention provides a decision engine and hub for decision making for uniform associate decisioning across an entity. The system comprises a platform agnostic decision and relay system for an entity. In this way, the system comprises a decision engine for associate performance, goals, coaching, or the like for management use and time management of the manager with respect to associate decisioning. The system extracts data points from one or more platforms within an entity about an associate along with learning resources to generate a decision and relay system for the particular associate. The system tailors decisions to identify specific functions or actions an associate should perform along with pinpointed direction for identification of how those functions are formulated and performed.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for real-time associate decisioning and relaying, the system comprising:
a memory device with computer-readable program code stored thereon;
a communication device;
a printing device for printing the resource distribution documents;
a processing device operatively coupled to the memory device and the communication device, wherein the processing device is configured to execute the computer-readable program code to:
integrate across entity platforms, wherein integrating across entity platforms comprises compatibly reading and transmitting in one or more platform;
compile associate and manager hierarchal data and learning resources across an entity;
generate a decision and relay tool comprising review metrics and actions for manager deployment to associates;
deploy, via an interactive interface the decision and relay tool, wherein the decision and relay tool is integrated within a device for performance and metric monitoring; and
collect review metrics and actions of associate and continually modify deployed review metrics and actions based on performance.

2. The system of claim 1, further comprising incorporating the decision and relay tool into workflow via initiation of the decision and relay tool upon start-up of a device on a network associated with the entity.

3. The system of claim 1, further comprising:
identifying an associate that interacts with a customer;
identifying the customer associated with the interaction;
tracking customer interaction with the entity via alternative channels within a predetermined window of time after the associate interaction; and
triggering associate benefits based on the customer interaction with the entity via the alternative channels.

4. The system of claim 1, further comprising providing a connectivity between associates for connection assessment issue based solution deployment, wherein the decision and relay tool performs learning of associate skills and deploys the associate via a connectivity across the entity for issue based solution deployment of the associate.

5. The system of claim 1, wherein integrating across entity platforms further comprises connect with and integrate for data distribution into the one or more platforms used by one or more lines of business across the entity providing a platform agnostic system integration for real-time associate decisioning and relaying, wherein the one or more platforms comprise employee management platforms, and product management platforms.

6. The system of claim 1, wherein generating review metrics and actions for manager deployment further comprises:
eliminating top performing associates from the review metrics;
identifying above average performing associates;
identify learning resources and actions performed by the above average performing associates; and
deploying, via the decision and relay tool, repeatable activities performed by the above average performing associates for review metrics and actions for associates.

7. The system of claim 1, wherein learning resources across the entity further comprises a suggested approach to presenting the review metrics and actions to the associate.

8. A computer program product for real-time associate decisioning and relaying, the computer program product comprising at least one non-transitory computer-readable medium having computer-readable program code portions embodied therein, the computer-readable program code portions comprising:
an executable portion configured for integrating across entity platforms, wherein integrating across entity platforms comprises compatibly reading and transmitting in one or more platform;
an executable portion configured for compiling associate and manager hierarchal data and learning resources across an entity;
an executable portion configured for generating a decision and relay tool comprising review metrics and actions for manager deployment to associates;
an executable portion configured for deploying, via an interactive interface the decision and relay tool, wherein the decision and relay tool is integrated within a device for performance and metric monitoring; and
an executable portion configured for collecting review metrics and actions of associate and continually modify deployed review metrics and actions based on performance.

9. The computer program product of claim 8, further comprising an executable portion configured for incorporating the decision and relay tool into workflow via initiation of the decision and relay tool upon start-up of a device on a network associated with the entity.

10. The computer program product of claim 8, further comprising:
an executable portion configured for identifying an associate that interacts with a customer;
an executable portion configured for identifying the customer associated with the interaction;
an executable portion configured for tracking customer interaction with the entity via alternative channels within a predetermined window of time after the associate interaction; and
an executable portion configured for triggering associate benefits based on the customer interaction with the entity via the alternative channels.

11. The computer program product of claim 8, further comprising an executable portion configured for providing a connectivity between associates for connection assessment issue based solution deployment, wherein the decision and relay tool performs learning of associate skills and deploys the associate via a connectivity across the entity for issue based solution deployment of the associate.

12. The computer program product of claim 8, wherein integrating across entity platforms further comprises connect with and integrate for data distribution into the one or more platforms used by one or more lines of business across the entity providing a platform agnostic system integration for real-time associate decisioning and relaying, wherein the one or more platforms comprise employee management platforms, and product management platforms.

13. The computer program product of claim 8, wherein generating review metrics and actions for manager deployment further comprises:
eliminating top performing associates from the review metrics;
identifying above average performing associates;
identify learning resources and actions performed by the above average performing associates; and
deploying, via the decision and relay tool, repeatable activities performed by the above average performing associates for review metrics and actions for associates.

14. The computer program product of claim 8, wherein learning resources across the entity further comprises a suggested approach to presenting the review metrics and actions to the associate.

15. A computer-implemented method for real-time associate decisioning and relaying, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
integrating across entity platforms, wherein integrating across entity platforms comprises compatibly reading and transmitting in one or more platform;
compiling associate and manager hierarchal data and learning resources across an entity;
generating a decision and relay tool comprising review metrics and actions for manager deployment to associates;
deploying, via an interactive interface the decision and relay tool, wherein the decision and relay tool is integrated within a device for performance and metric monitoring; and
collecting review metrics and actions of associate and continually modify deployed review metrics and actions based on performance.

16. The computer-implemented method of claim 15, further comprising incorporation of the decision and relay tool into workflow via initiation of the decision and relay tool upon start-up of a device on a network associated with the entity.

17. The computer-implemented method of claim 15, further comprising:
identifying an associate that interacts with a customer;
identifying the customer associated with the interaction;
tracking customer interaction with the entity via alternative channels within a predetermined window of time after the associate interaction; and
triggering associate benefits based on the customer interaction with the entity via the alternative channels.

18. The computer-implemented method of claim 15, further comprising providing a connectivity between associates for connection assessment issue based solution deployment, wherein the decision and relay tool performs learning of associate skills and deploys the associate via a connectivity across the entity for issue based solution deployment of the associate.

19. The computer-implemented method of claim 15, wherein integrating across entity platforms further comprises connect with and integrate for data distribution into the one or more platforms used by one or more lines of business across the entity providing a platform agnostic system integration for real-time associate decisioning and relaying, wherein the one or more platforms comprise employee management platforms, and product management platforms.

20. The computer-implemented method of claim 15, wherein generating review metrics and actions for manager deployment further comprises:
eliminating top performing associates from the review metrics;
identifying above average performing associates;
identify learning resources and actions performed by the above average performing associates; and
deploying, via the decision and relay tool, repeatable activities performed by the above average performing associates for review metrics and actions for associates.
